(19) United States
(12) Patent Application Publication
(10) Pub. No.: US 2013/0161947 A1
(43) Pub. Date: Jun. 27, 2013

(54) Metal clamp with a plastic sleeve

(71) Applicant: Lei Zhang, Tianjin (CN)

(72) Inventor: Lei Zhang, Tianjin (CN)

(73) Assignee: LINK-TECH (TIANJIN) METAL PRODUCTS CO., LTD.

(21) Appl. No.: 13/358,212

(22) Filed: Jan. 25, 2012

(30) Foreign Application Priority Data
Dec. 22, 2011 (CN) 201120543652.1

(51) Int. Cl. F16L 25/00

(52) U.S. Cl. 285/420

(57) ABSTRACT

A metal clamp with a plastic sleeve, includes a clamp body made of metal, wherein the plastic sleeve is disposed at the clamp body to locate the clamp body. The plastic sleeve can be classified into an integral plastic sleeve and a split type plastic sleeve. The clamp body is fixed to the plastic sleeve by a circumferential groove on the plastic sleeve. The present invention has the advantage as follows. A shaking of the metal clamp in construction is avoided, the plastic pipe and the pipe fitting is able to achieve firm connection. In addition, fittings between the inner diameter on both ends of the plastic sleeve and the plastic pipe is capable of keeping a relative position among the metal clamp, the plastic pipe and the pipe fitting.

### BACKGROUND OF THE PRESENT INVENTION

1. Field of Invention

The present invention relates to a tool for pipe fitting, and more particularly to a metal clamp with a plastic sleeve.

2. Description of Related Arts

Plastic pipes are widely used in industry, agriculture and urban construction, for example, water supply and coal gas supply. The plastic pipes are connected by pipe fittings, so the pipe fittings are critical to the reliability and the sealing effect of the plastic pipes. In order to connect pipe fittings with pipes rapidly, accurately and firmly, many connecting methods with auxiliary plastic parts are used, such as clamping the metal clamp to connect the pipe fittings with the plastic pipes. But the ways of connecting mentioned above all have different disadvantages as follows. 1. In traditional way, the clearance between the clamp and the plastic pipe causes the clamp to shake freely, which makes the clamping operation very inconvenient. 2. After clamping, the sealing effect of the plastic pipe is bad; in addition, the cost is too high, which increases the construction costs.

### SUMMARY OF THE PRESENT INVENTION

In order to solve the technical problems in the prior art, the present invention provides a metal clamp with a plastic sleeve. The metal clamp with a plastic sleeve provided has simple operating and good locating effect. In addition, the metal clamp with a plastic sleeve provided is able to ensure the plastic pipe well sealed after clamping, and improve the installation efficiency, and has strong practicability.

In order to solve the technical problems in the prior art, the present invention provides:

a metal clamp with a plastic sleeve, comprising a clamp body made of metal, wherein the plastic sleeve is disposed at the clamp body to locate the clamp body.

The present invention can adopt the following technical proposals.

The plastic sleeve is an integral plastic sleeve.

A convex is disposed on a radial inner side of an end face of the integral plastic sleeve for locating the clamp body; an observation hole is set on a circumferential surface of the end to observe whether a plastic pipe is installed in place; a circumferential groove is disposed at middle of an inner diameter of the plastic sleeve to install the clamp body, and the circumferential groove is tightly installed with the clamp body.

A distance for the clamp to work conveniently is set between the convex on the radical inner side of the end face and the clamp body.

According to another preferred embodiment of the present invention, the plastic sleeve is a split type plastic sleeve.

The split type plastic sleeve comprises a front sleeve portion and a rear sleeve portion, wherein a connecting convex is provided on an outer surface at one end of the front sleeve portion, a connecting groove is provided on an inner surface at one end of the rear sleeve portion, the convex of the front sleeve portion connects the groove of the rear sleeve portion by barbed crimping.

A convex is disposed on a radial inner side of an end face of the front sleeve portion; an observation hole is set on the end to observe whether a plastic pipe is installed in place; a circumferential groove is disposed at an inner diameter of the front sleeve portion to install the clamp body, and the clamp body is fixed to the plastic sleeve by the circumferential groove.

The present invention has the following benefit. A plastic sleeve is provided on the clamp body for locating. By putting an external end face of the convex against a limiting surface of the pipe fitting, the distance for the clamp to work is determined. By fittings between the inner diameter on both ends of the plastic sleeve and the plastic pipe, a shaking of the metal clamp in construction is avoided, the plastic pipe and the pipe fitting is able to achieve firm connection. In addition, fittings between the inner diameter on both ends of the plastic sleeve and the plastic pipe is capable of keeping a relative position among the metal clamp, the plastic pipe and the pipe fitting. The determining of the position is fast, accurate and convenient. The present invention is suitable for the accurate position fitting of a straight through pipe fitting, a three-way pipe fitting, an elbow pipe fitting or a valve. Furthermore, the present invention is convenient to use, capable of greatly improving the overall quality of the pipe connection, improving the efficiency of construction and installation.

These and other objectives, features, and advantages of the present invention will become apparent from the following detailed description, the accompanying drawings, and the appended claims.

### BRIEF DESCRIPTION OF THE DRAWINGS

FIG. 1 is a structure diagram of a metal clamp with a plastic sleeve according to a first preferred embodiment of the present invention.

FIG. 2 is a three-dimensional sectional view of FIG. 1.

FIG. 3 is a plane sectional view of FIG. 1.

FIG. 4 is a structure diagram of the plastic sleeve according to the first preferred embodiment of the present invention.

FIG. 5 is a three-dimensional sectional view of FIG. 4.

FIG. 6 is a structure diagram of a metal clamp with a plastic sleeve in use conditions according to the first preferred embodiment of the present invention.

FIG. 7 is a three-dimensional exploded view of FIG. 6.

FIG. 8 is a structure diagram of a metal clamp with a plastic sleeve according to a second preferred embodiment of the present invention.

FIG. 9 is a three-dimensional sectional view of FIG. 8.

FIG. 10 is a structure diagram of the plastic sleeve according to the second preferred embodiment of the present invention.

FIG. 11 is a structure diagram of the metal clamp with a plastic sleeve in use conditions according to the second preferred embodiment of the present invention.

FIG. 12 is a three-dimensional decomposition view of FIG. 11.

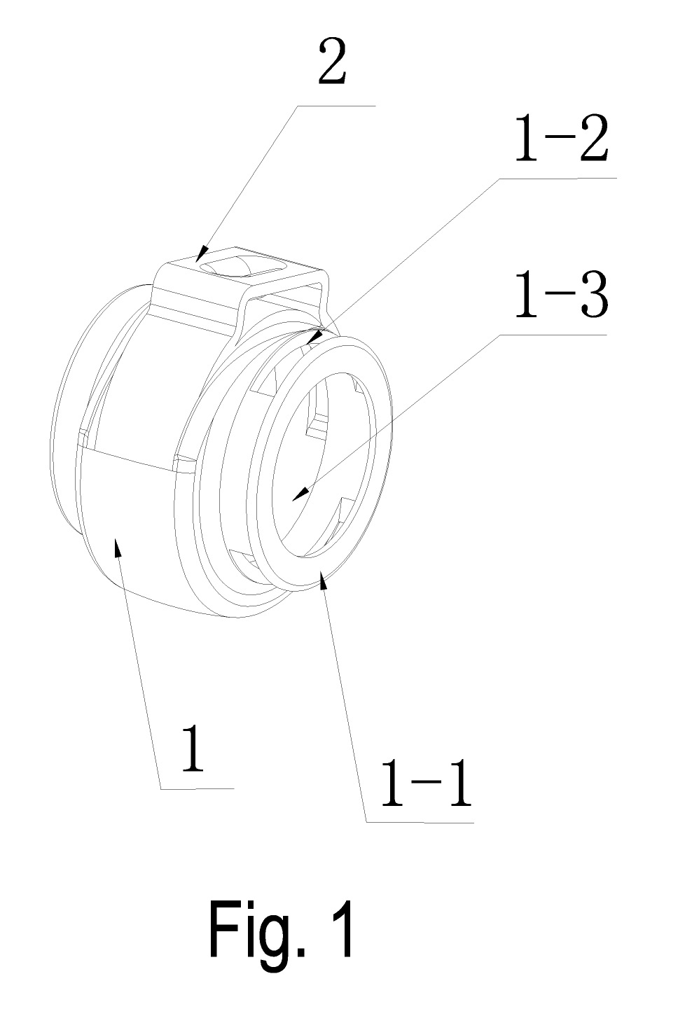

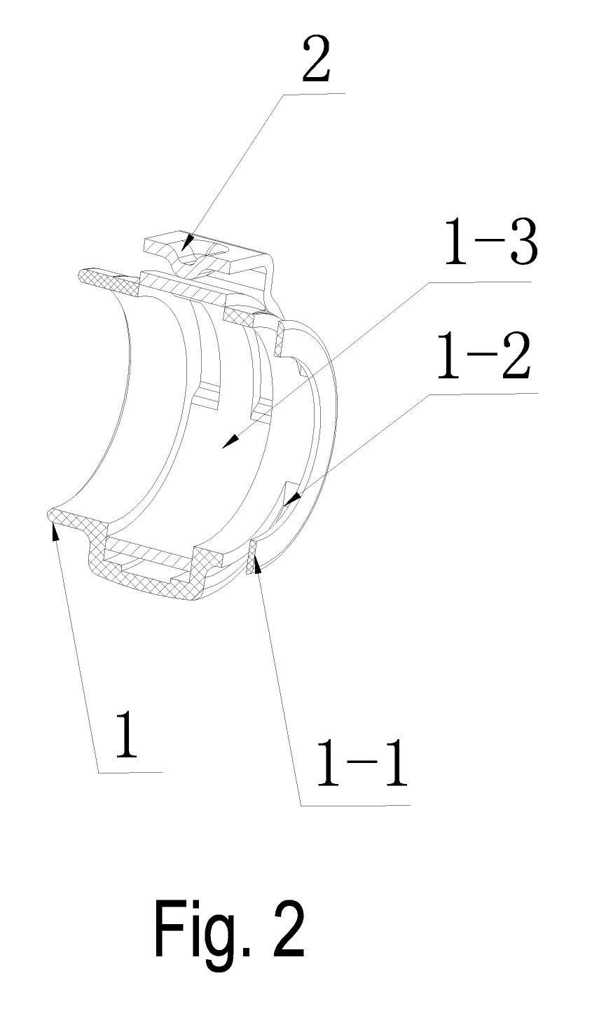

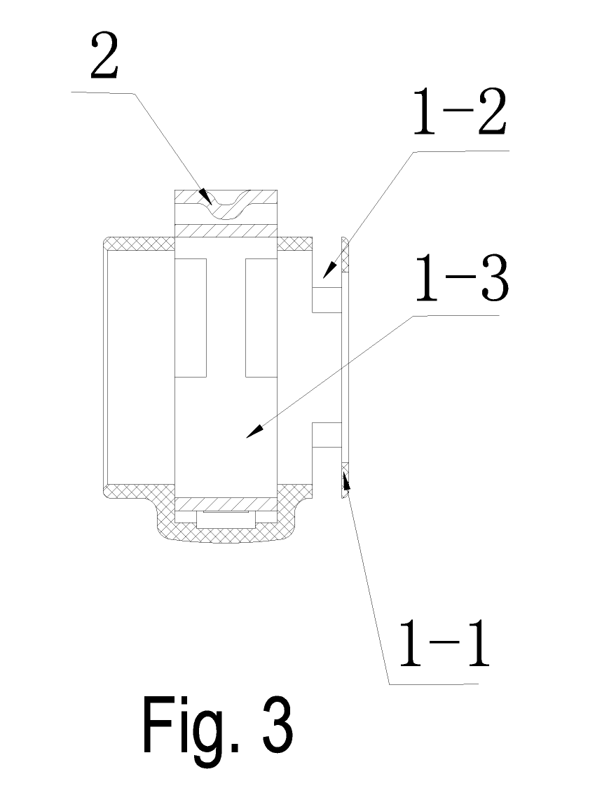

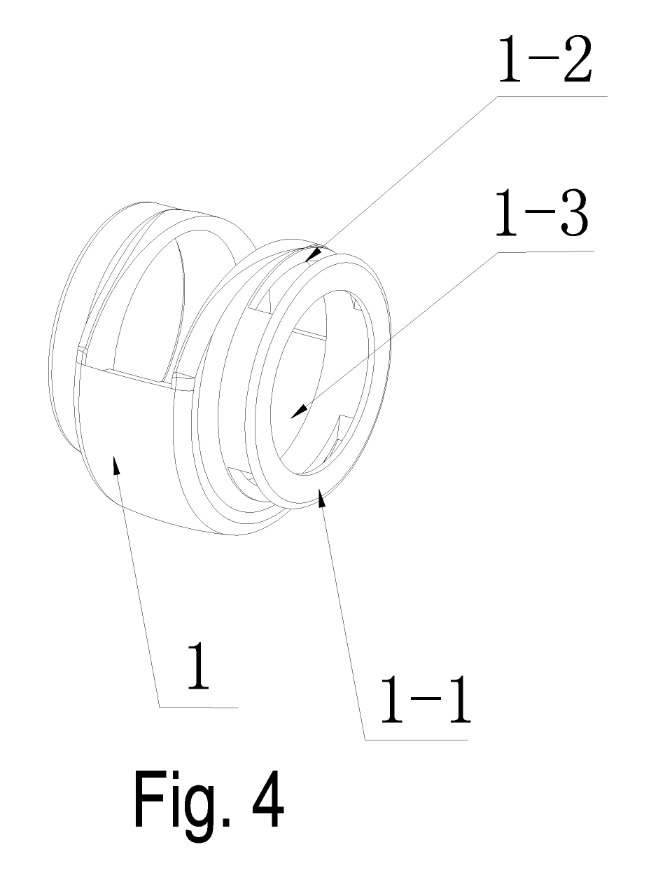

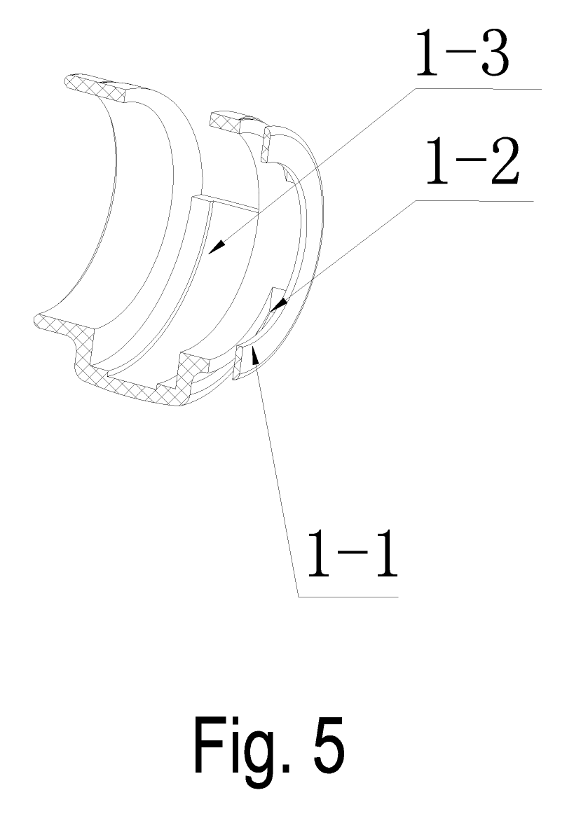

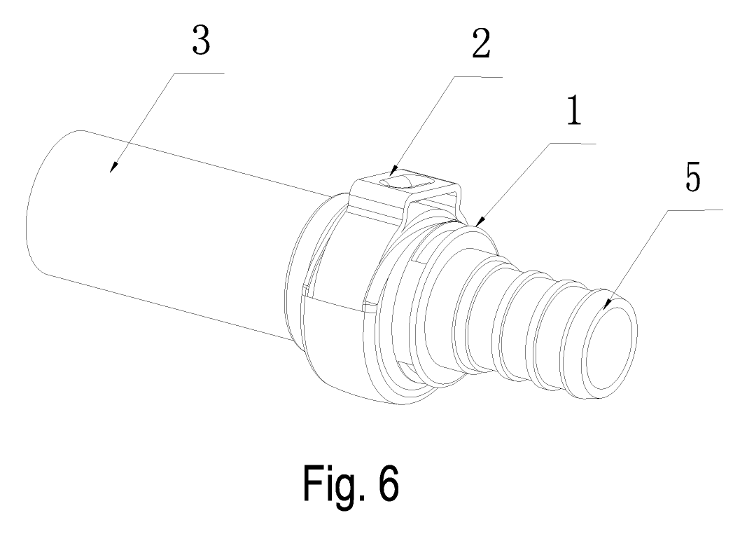

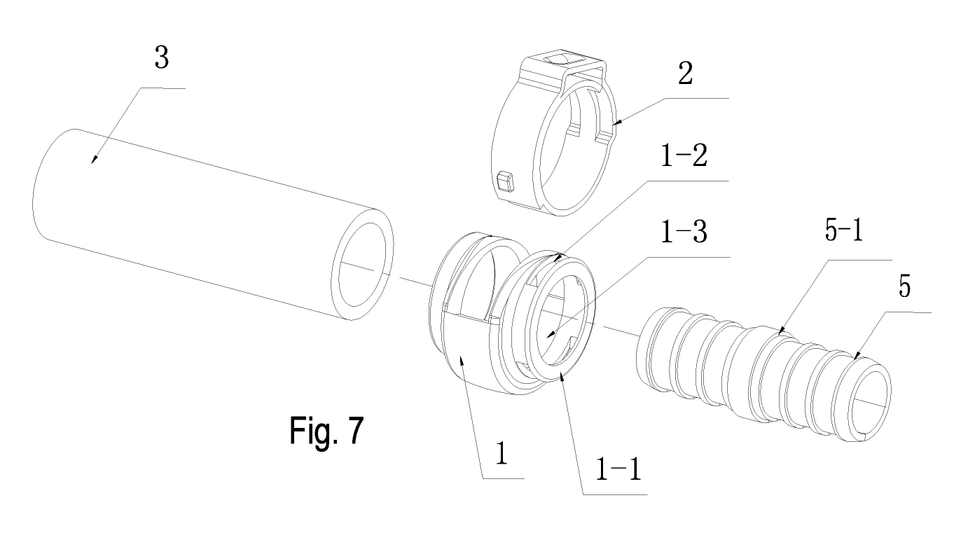

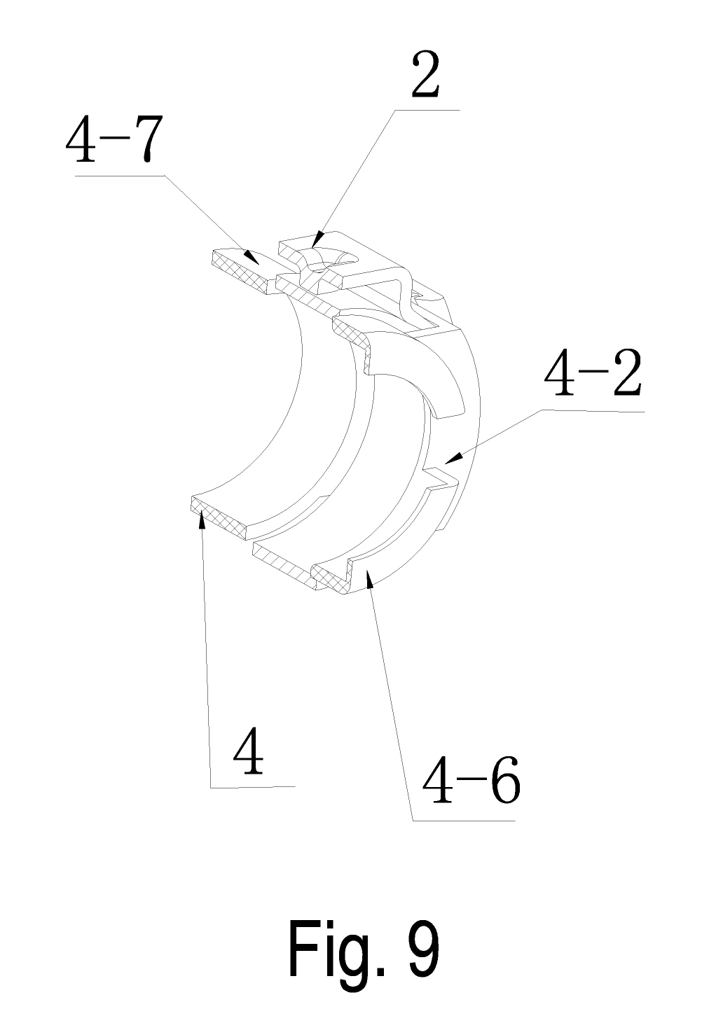

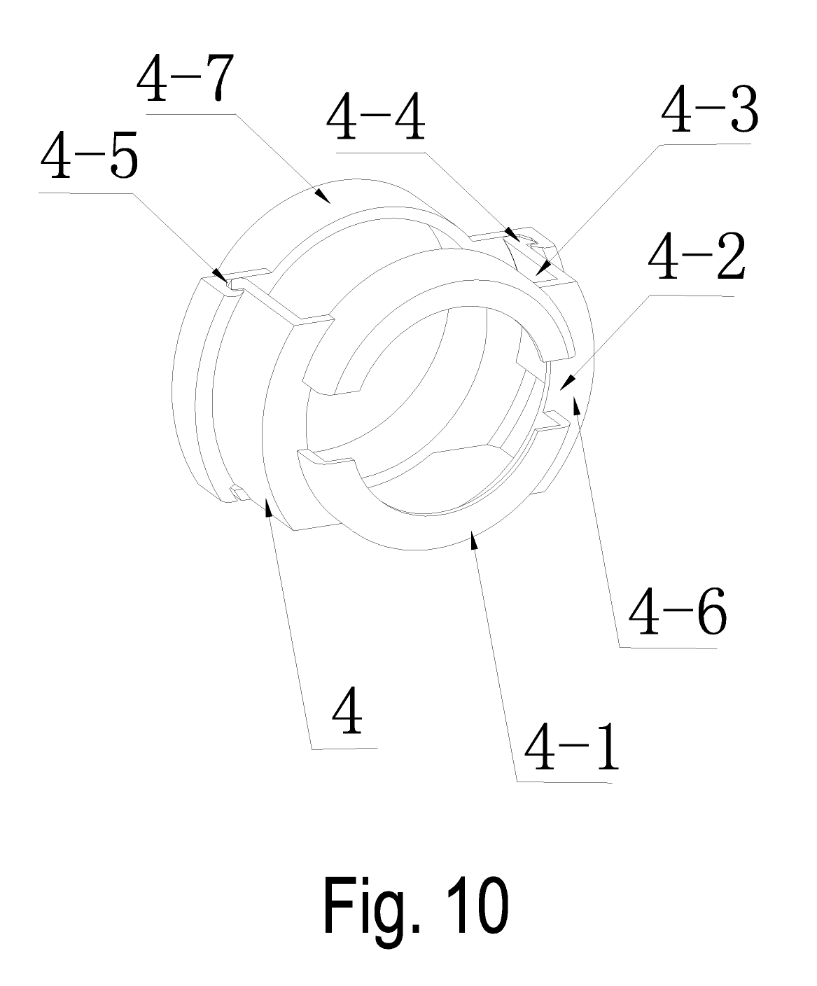

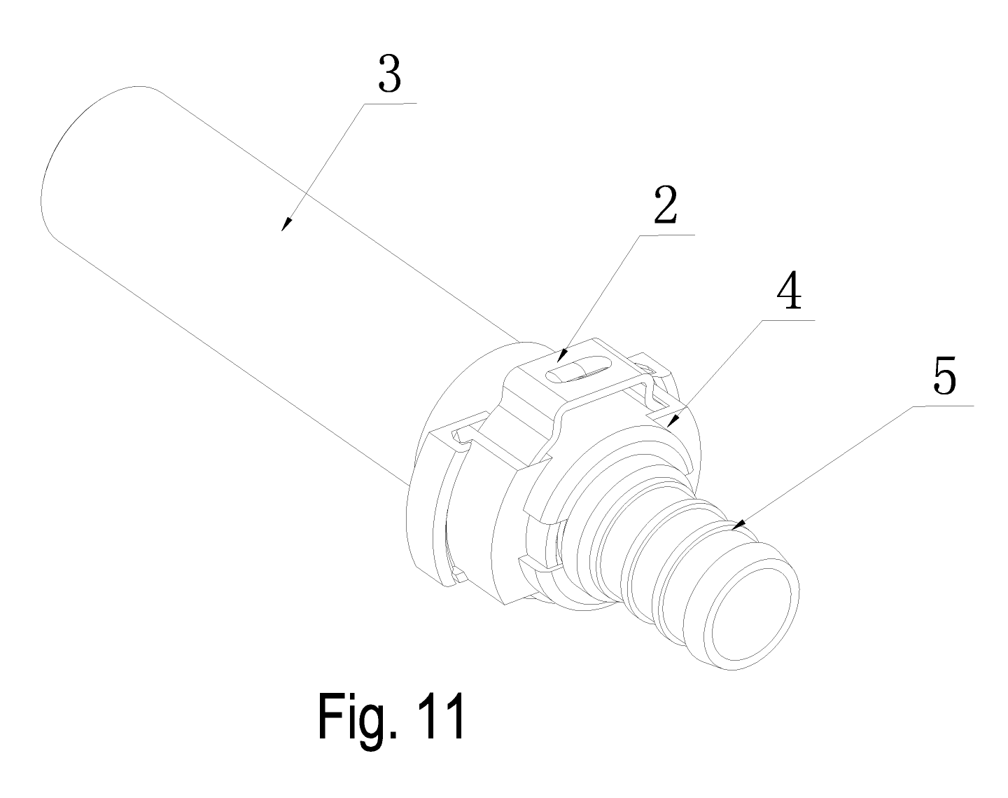

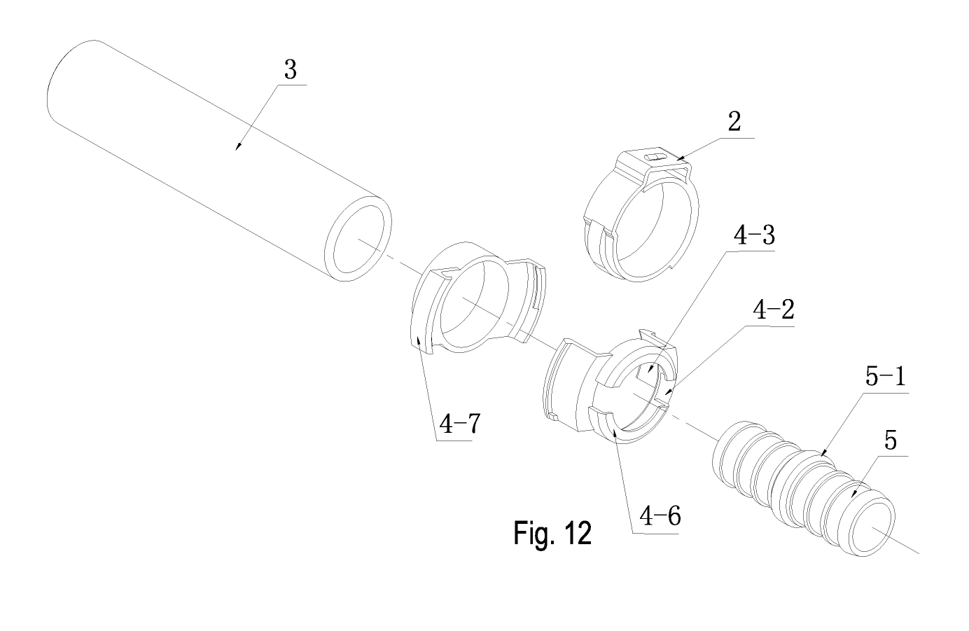

The number of elements in FIG. 1-12 is as follows:
1: integral plastic sleeve,
1-1: convex,
1-2: observation hole,
1-3: circumferential groove,
2: clamp body,
3: plastic pipe,
4: split type plastic sleeve,
4-1: convex,
4-2: observation hole,
4-3: circumferential groove,
4-4: connecting convex,
4-5: connecting groove,
4-6: front sleeve portion,
4-7: rear sleeve portion,
5: pipe fitting,
5-1: limiting surface.

### DETAILED DESCRIPTION OF THE PREFERRED EMBODIMENT

In order to make a further understanding of content, characteristic and effects of the present invention, preferred embodiments with drawings illustrating in detail are listed as follows.

Referring to FIG. 1-5 of the drawings, a metal clamp with a plastic sleeve according to a first preferred embodiment of the present invention is illustrated, comprising a clamp body 2 made of metal, wherein the plastic sleeve 1 is disposed at the clamp body 2 to locate the clamp body 2. In the first preferred embodiment, the plastic sleeve is an integral plastic sleeve; a convex 1-1 is disposed on a radial inner side of an end face of the integral plastic sleeve for locating the clamp body; an observation hole 1-2 is set on a circumferential surface of the end to observe whether a plastic pipe is installed in place; a circumferential groove 1-3 is disposed at middle of an inner diameter of the plastic sleeve to install the clamp body, the clamp body 1 is fixed to the plastic sleeve by the circumferential groove 1-3. In the first preferred embodiment, an inner diameter of the circumferential groove 1-3 and an outer diameter of the clamp body 1 are equal, so the circumferential groove 1-3 is tightly installed with the clamp body 1. A distance for the clamp to work conveniently is set between the convex on the radical inner side of the end face and the clamp body. The distance determines a distance range that meets F1807 standard while the clamp body is working. When an external end face of the convex is against a limiting surface 4-1 of the pipe fitting 4, seen in the observation hole, the plastic pipe 3 is against the plastic sleeve convex inner end face, indicates the pipe fitting is installed in place.

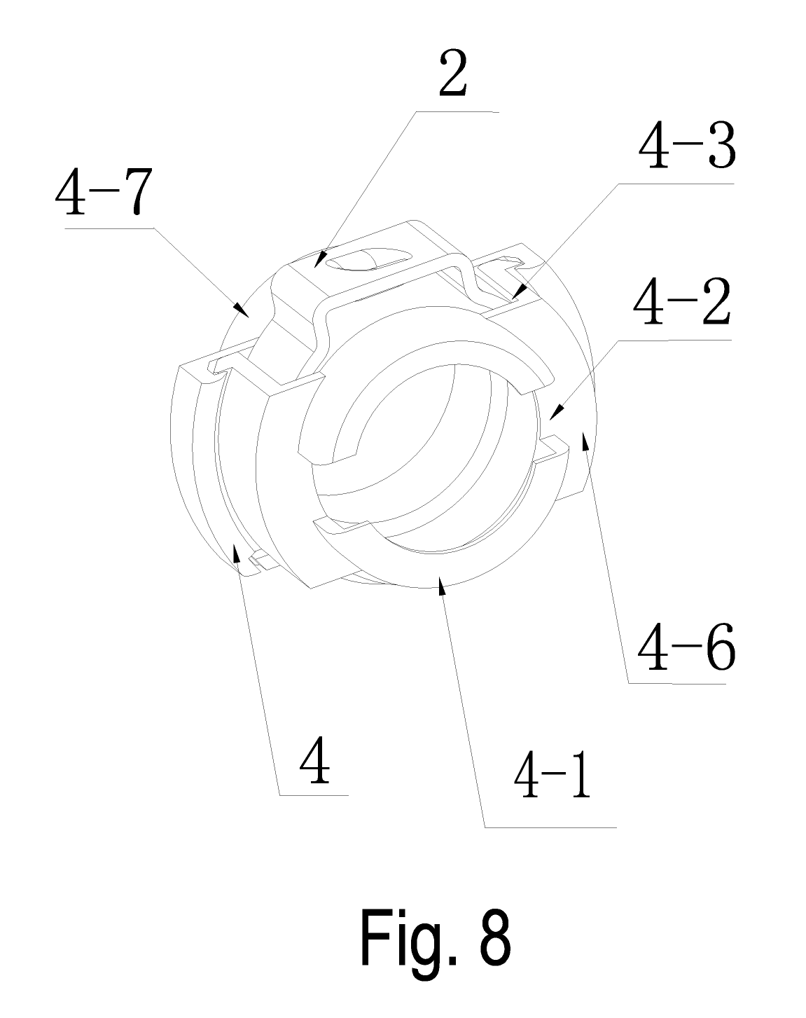

Referring to FIG. 8-10 of the drawings, a metal clamp with a plastic sleeve according to a second preferred embodiment of the present invention is illustrated, comprising a clamp body 2 made of metal, wherein the plastic sleeve 1 is disposed at the clamp body 2 to locate the clamp body 2. The plastic sleeve is a split type plastic sleeve 4. The split type plastic sleeve comprises a front sleeve portion 4-6 and a rear sleeve portion 4-7, wherein a connecting convex 4-4 is provided on an outer surface at one end of the front sleeve portion, a connecting groove 4-5 is provided on an inner surface at one end of the rear sleeve portion; the convex of the front sleeve portion connects the groove of the rear sleeve portion by barbed crimping. A convex 4-1 is disposed on a radial inner side of an end face of the front sleeve portion for locating the clamp body; an observation hole 4-2 is set on a circumferential surface of the end to observe whether a plastic pipe is installed in place; a circumferential groove 4-3 is disposed at an inner diameter of the front sleeve portion to install the clamp body, and the clamp body is fixed to the plastic sleeve by the circumferential groove 4-3. In the second preferred embodiment, an inner diameter of the circumferential groove 1-3 and an outer diameter of the clamp body 1 are equal, so the circumferential groove 1-3 is tightly installed with the clamp body 1. A distance for the clamp to work conveniently is set between the convex on the radical inner side of the end face and the clamp body. The distance determines a distance range that meets F1807 standard while the clamp body is working. When an external end face of the convex is against a limiting surface 4-1 of the pipe fitting 4, seen in the observation hole, the plastic pipe 3 is against the plastic sleeve convex inner end face, indicates the pipe fitting is installed in place.

The present invention works as follows. Telescope the metal clamp body 1 into the integral plastic sleeve 1 or the split type plastic sleeve 4, telescope the clamp of the plastic sleeve into the plastic pipe 3, then put the pipe fitting 5 into the plastic pipe, make the convex 1-1 of the integral plastic sleeve or the external end face of the split type plastic sleeve 4 against the limiting surface of the pipe fitting 5. When seen in the observation hole, the plastic pipe 3 is against the plastic sleeve convex inner end face, the pipe fitting is installed in place. Then clamp the clamp and finish the connection between the plastic pipe and the pipe fitting.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A metal clamp, comprising a clamp body made of metal, and a plastic sleeve disposed at said clamp body to locate said clamp body.

2. The metal clamp as recited in claim 1, wherein said plastic sleeve is an integral plastic sleeve.

3. The metal clamp as recited in claim 2, wherein a convex is disposed on a radial inner side of an end face of said integral plastic sleeve for locating said clamp body; an observation hole is set on a circumferential surface of said end to observe whether a plastic pipe is installed in place; a circumferential groove is disposed at middle of an inner diameter of said plastic sleeve to install said clamp body, and said circumferential groove is tightly installed with said clamp body.

4. The metal clamp as recited in claim 3, wherein a distance for said metal clamp to work conveniently is set between said convex on said radical inner side of said end face and said clamp body.

5. The metal clamp as recited in claim 1, wherein said plastic sleeve is a split type plastic sleeve.

6. The metal clamp as recited in claim 5, wherein said split type plastic sleeve comprises a front sleeve portion and a rear sleeve portion, wherein a connecting convex is provided on an outer surface at one end of said front sleeve portion, a connecting groove is provided on an inner surface at one end of said rear sleeve portion, said convex of said front sleeve portion connects said groove of said rear sleeve portion by barbed crimping.

7. The metal clamp as recited in claim 6, wherein a convex is disposed on a radial inner side of an end face of said front sleeve portion for locating the clamp body; an observation hole is set on a circumferential surface of said end to observe whether a plastic pipe is installed in place; a circumferential groove is disposed at an inner diameter of said front sleeve portion to install said clamp body, and said clamp body is fixed to said plastic sleeve by said circumferential groove.
